(19) United States
(12) Patent Application Publication
(10) Pub. No.: US 2013/0111873 A1
(43) Pub. Date: May 9, 2013

(54) AIRCRAFT TURBOJET ENGINE FAN CASING

(71) Applicants: AIRCELLE, Gonfreville L'orcher (FR); SNECMA, Paris (FR)

(72) Inventors: Wouter BALK, Melun (FR); François GALLET, Paris (FR); Nicolas DEZEUSTRE, Le Havre (FR); Oliver KERBLER, Antony (FR)

(73) Assignees: SNECMA, Paris (FR); AIRCELLE, Gonfreville L'orcher (FR)

(21) Appl. No.: 13/718,532

(22) Filed: Dec. 18, 2012

Related U.S. Application Data
(63) Continuation of application No. PCT/FR2011/051382, filed on Jun. 16, 2011.

(30) Foreign Application Priority Data
Jun. 18, 2010 (FR) 1054845

(51) Int. Cl. F02C 3/08

(52) U.S. Cl. 60/226.1; 415/220

(57) ABSTRACT

An aircraft turbojet engine fan casing in the form of a box section is provided by the present disclosure. The box section includes a radially interior wall of which is able to form an internal skin of a cold air flow duct of a nacelle in which said turbojet engine is intended to be mounted, and a radially exterior wall of which is able to form an external skin of said nacelle, the box forming a module forming an entire thickness of the nacelle, and placed between an upstream portion of the nacelle, forming the air intake, and a downstream casing portion, on which a cascade edge of a thrust reverser can be fixed.

### CROSS-REFERENCE TO RELATED APPLICATIONS

This application is a continuation of International Application No. PCT/FR2011/051382 filed on Jun. 16, 2011, which claims the benefit of FR 10/54845, filed on Jun. 18, 2010. The disclosures of the above applications are incorporated herein by reference.

### FIELD

The present disclosure relates to an aircraft turbojet engine fan casing.

### BACKGROUND

The statements in this section merely provide background information related to the present disclosure and may not constitute prior art.

As is known in itself, and shown in the appended FIG. 1, a dual-flow turbojet engine nacelle traditionally comprises an outer structure 1 having an upstream portion 3 forming an air intake, an intermediate portion 5 whereof the inner skin 6 forms a casing for the fan 7 of the engine, and a downstream portion 9 that may incorporate thrust reversal means.

This nacelle also includes an inner structure 11 having a fairing 13 for the engine 15.

The outer structure 1 defines, with the inner structure 11, an annular air duct 17, often called “cold air duct,” as opposed to the hot air created by the engine 15.

The fan 7 essentially consists of a propeller provided with blades 19, which are rotatably mounted on a stationary hub 21 connected to the fan casing 6 by a plurality of stationary arms 25, which may for example be distributed at 120 degree intervals.

Upstream of these stationary arms are airflow-straightening vanes 23, also called OGV (“Outlet Guide Vanes”), which make it possible to straighten the cold air flow created by the fan 7.

The fan casing 6, which is generally in the shape of a cylinder, has a significant weight, which it would be desirable to reduce.

Furthermore, integrating the fan casing 6 into the intermediate portion 5 of the outer structure 1 of the nacelle 1 causes many fastenings, some of which are complex to carry out, in particular due to the presence of the outer skin of the outer structure of the nacelle.

### SUMMARY

The present disclosure thus aims to provide a fan casing to allow overall weight savings, as well as easier assembly.

This is achieved with an aircraft turbojet engine fan casing, notable in that it is in the form of a box section, the radially interior wall of which is able to form the internal skin of the cold air flow duct of a nacelle in which said turbojet engine is intended to be mounted, and the radially exterior wall of which is able to form the external skin of said nacelle.

Owing to this box structure, it is possible to obtain excellent structural strength of the fan casing, with very thin skins, whereof the overall weight is lower than that of a traditional casing.

Since the outer wall of that box also acts as a substitute for the outer skin of the corresponding portion of the nacelle, the total mass balance is still further improved.

It should also be noted that this box form allow a configurable assembly of the fan casing, between the upstream and downstream portions of the nacelle; the fastenings of these upstream and downstream portions on the box are easily accessible, which contributes to the ease of assembly.

According to other optional features of this fan casing according to the present disclosure:
a ribbing is placed between said inner and outer walls: this makes it possible to strengthen the box structure;
at least one of said walls is formed from a composite material: this makes it possible to save in terms of weight;
an intermediate fan blade retaining layer is placed between said inner and outer skins: this skin makes it possible to retain a blade that is detached from the fan, and thereby avoid completely ruining the turbojet engine and the nacelle surrounding it;
said intermediate layer can be made from aramid fibers: this material offers an excellent weight/strength balance.

The present disclosure also relates to an aircraft turbojet engine that is remarkable in that it comprises a fan casing as previously described.

The present disclosure also relates to an aircraft propulsion assembly, which is remarkable in that it comprises a nacelle whereof the intermediate portion is formed by a turbojet engine fan casing as previously described.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a cross-sectional view of half of a nacelle and its associated turbojet engine according to the prior art, described in the preamble to the present invention;

FIG. 2 is a diagrammatic view of zone II of the assembly shown in FIG. 1;

FIG. 3 is a view of a zone similar to zone III of FIG. 1, of a nacelle incorporating a fan casing according to the invention; and

FIG. 4 is a diagrammatic view of zone IV of FIG. 3.

In all of these figures, identical or similar references designate identical or similar members or sets of members.

It will also be noted that a three-axis reference has been provided in these figures showing the X, Y and Z axes. These three axes respectively represent the longitudinal, transverse and vertical directions of the nacelle when it is installed on an aircraft.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As shown in FIG. 2, in a traditional nacelle and turbojet engine assembly, the fan casing 6 has a generally substantially cylindrical shape, and a substantially open C-shaped section.

This fan casing 6, which defines part of the inner skin of the nacelle, and therefore a portion of the cold air duct 17, can be formed from a metal alloy or a composite material.

This fan casing 6 has both a structural function, contributing to the general strength of the nacelle, and a retention function for the blades 19 of the fan 7: this casing is in fact provided to be strong enough to prevent the passage of a blade 19 that may become detached from the hub 21, and which could then ruin the assembly of the nacelle and the turbojet engine.

One or more layers 27 of material capable of withstanding the crossing of a blade 19 are arranged at the outer periphery of the casing 6: the material forming these layers can for example be a composite fabric with a base of aramid fibers.

Reference will now be made to FIGS. 3 and 4, which show a nacelle incorporating a fan casing according to the invention.

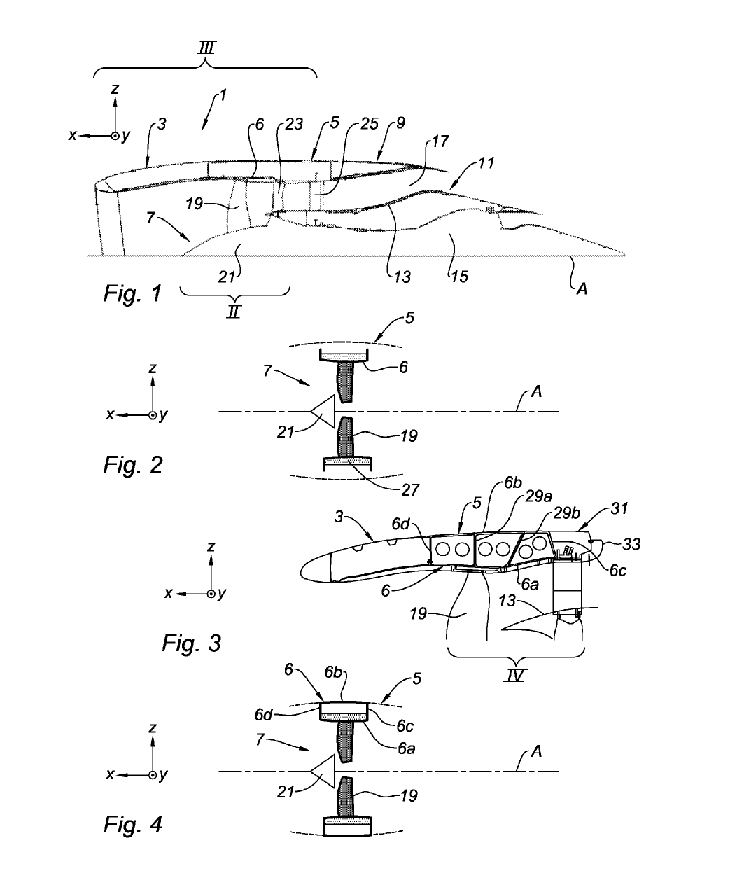

As shown in these two figures, unlike the traditional arrangement of FIGS. 1 and 2, the casing 6 is in the shape of a box of revolution, having an inner wall 6a, an outer wall 6b, and two side walls 6c and 6d.

The inner wall 6a forms part of the inner skin of the nacelle, i.e. the skin that defines the cold air duct 17.

The outer wall 6b of the casing 6 emerges on the outside of the nacelle, i.e. it forms a portion of the outer skin of the intermediate portion 5 of that nacelle.

Each of the walls 6a to 6b can be formed with a base of a metal alloy and/or from a suitable composite material.

It is also possible to provide that one or more layers 27 of material withstanding the passage of the blades 19 of the fan 7 are arranged inside the box thus formed.

It is also possible to provide that the box has longitudinal and/or circumferential internal partitions of type 29a, 29b (see FIG. 3), forming a ribbing and thereby contributing to the strength of the box 6.

The box structure of the casing 6 makes it possible to minimize the thickness of the walls 6a and 6b it forms, while preserving an excellent structural strength, completed by an ability to withstand the crossing of blades 19 procured by the layers of material 27 arranged inside that box.

Furthermore, as can be understood in light of the preceding, this box 6 forms a sort of module forming the entire thickness of the nacelle, and placed between the upstream portion 3 of the nacelle, forming the air intake, and a downstream casing portion 31, on which the cascade edge 3 of a thrust reverser can be fixed.

This configurable nature of the casing 6 allows it to be integrated into the rest of the nacelle more simply, and allows easy placement of suitable fastening means with the portions 3 and 31.

It will therefore be understood that the fan casing according to the invention makes it possible to obtain a better weight/structural strength compromise than the casings of the prior art, as well as a much easier configurable assembly.

Of course, the present disclosure is in no way limited to the embodiments described and shown.

It is thus for example possible to consider the inner wall 6a and/or the outer wall 6b of the casing 6 each having a blade 19 retention function, in addition to and/or in place of that of the layers of material 27.

It is thus also possible to consider the box casing 6 extending upstream as far as the air intake and/or downstream as far as the cascade edge.

What is claimed is:

1. An aircraft turbojet engine fan casing in the form of a box section, a radially interior wall of which is able to form an internal skin of a cold air flow duct of a nacelle in which said turbojet engine is intended to be mounted, and a radially exterior wall of which is able to form an external skin of said nacelle, the box forming a module forming an entire thickness of the nacelle, and placed between an upstream portion of the nacelle, forming the air intake, and a downstream casing portion, on which a cascade edge of a thrust reverser can be fixed.

2. The fan casing according to claim 1, characterized in that it comprises a ribbing placed between said inner and outer walls.

3. The casing according to claim 1, characterized in that at least one of said walls is formed from a composite material.

4. The casing according to claim 1, characterized in that it comprises an intermediate fan blade retaining layer between said inner and outer skins.

5. The casing according to claim 4, characterized in that said intermediate layer can be made from aramid fibers.

6. An aircraft turbojet engine, characterized in that it comprises a fan casing as set forth in claim 1.

7. An aircraft propulsion assembly, characterized in that it comprises a nacelle whereof the intermediate portion is formed by a turbojet engine fan casing according to claim 6.

8. The propulsion assembly according to claim 7, characterized in that said casing extends as far as the cascade edge of said nacelle.
